(19) United States
(12) Patent Application Publication
(10) Pub. No.: US 2013/0010252 A1
(43) Pub. Date: Jan. 10, 2013

(54) ADVERTISING GLASSES

(76) Inventor: Bruce Marc Coustillas, Miami, FL (US)

(21) Appl. No.: 13/542,659

(22) Filed: Jul. 5, 2012

Related U.S. Application Data
(60) Provisional application No. 61/505,957, filed on Jul. 8, 2011.

(51) Int. Cl. G02C 11/02; G06Q 90/00; G02C 7/16

(52) U.S. Cl. 351/46; 351/51; 705/500

(57) ABSTRACT

Advertising glasses have a one-way vision window film on the lens, printed with a message for advertising, marketing or the like. The glasses can be fashion glasses, prescription glasses, sunglasses, or the like. The advertising/marketing message can be printed on one-way vision sticky paper, cut to the proper size for the glasses' lens, and applied to the lens. The advertising glasses can be used for events, photo opportunities, contests, or other types of advertising, marketing or promotional purposes.

### CROSS-REFERENCE TO RELATED APPLICATION

This application claims the benefit of priority of U.S. provisional application No. 61/505,957, filed Jul. 8, 2011, the contents of which are herein incorporated by reference.

### BACKGROUND OF THE INVENTION

The present invention relates to advertising glasses and, more particularly, to advertising glasses that have a one-way vision window film on the lens, printed in any kind of message for advertising, marketing and the like.

Advertisers often seek new and creative ways to deliver their message. Each year, millions of dollars are spent on billboards, television advertising, radio advertising, internet advertising, and the like. Moreover, advertisers print their names and logos on various items, such as hats, shirts, mugs, drink glasses and the like, all in efforts to spread their brand names.

With the growth in social media and the ability to take a picture and quickly share it with a large group of friends online, advertisers have found that their products sometimes show up in these photos, much to the delight of the advertiser. However, the items on which the advertiser's brands and logos appear on are limited, typically appearing on hats or shirts being worn at the time of the photo. Advertisers continually try to find new options to make them more famous and more visible.

As can be seen, there is a need for a wearable product that can containing advertising that can be worn by users and that can deliver an advertising or marketing message.

### SUMMARY OF THE INVENTION

In one aspect of the present invention, an advertising system comprises a pair of glasses having lenses; a one-way vision adhesive window film operable to be adhered to the lenses of the pair of glasses; and a printed advertising/marketing message disposed on the one-way vision adhesive window film.

In another aspect of the present invention, an advertising system comprises a pair of glasses having lenses; a one-way vision adhesive window film operable to be adhered to the lenses of the pair of glasses; a plurality of perforations disposed in the one-way vision adhesive window film; an adhesive to secure the one-way vision adhesive window film to the lenses of the pair of glasses; and a printed advertising/marketing message disposed on the one-way vision adhesive window film.

In a further aspect of the present invention, a method of advertising comprises providing pair of glasses having lenses with a one-way vision window film disposed thereupon; printing advertisement material on the one-way vision window film; and urging a user to wear the glasses.

These and other features, aspects and advantages of the present invention will become better understood with reference to the following drawings, description and claims.

### BRIEF DESCRIPTION OF THE DRAWINGS

FIG. 1 is a perspective view of a user wearing advertising glasses according to an exemplary embodiment of the present invention;

FIG. 2 is an exploded perspective view of the advertising glasses of FIG. 1;

FIG. 3 is a front view of advertising glasses showing an exemplary advertising/marketing message;

FIG. 4 is a cross-sectional view of the advertising glasses as taken along line 4-4 of FIG. 3; and

FIG. 5 is a flowchart describing an exemplary method for making advertising glasses.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides advertising glasses that have a one-way vision window film on the lens, printed with a message for advertising, marketing or the like. The glasses can be fashion glasses, prescription glasses, sunglasses, or the like. The advertising/marketing message can be printed on one-way vision sticky paper, cut to the proper size for the glasses' lens, and applied to the lens. The advertising glasses can be used for events, photo opportunities, contests, or other types of advertising, marketing or promotional purposes.

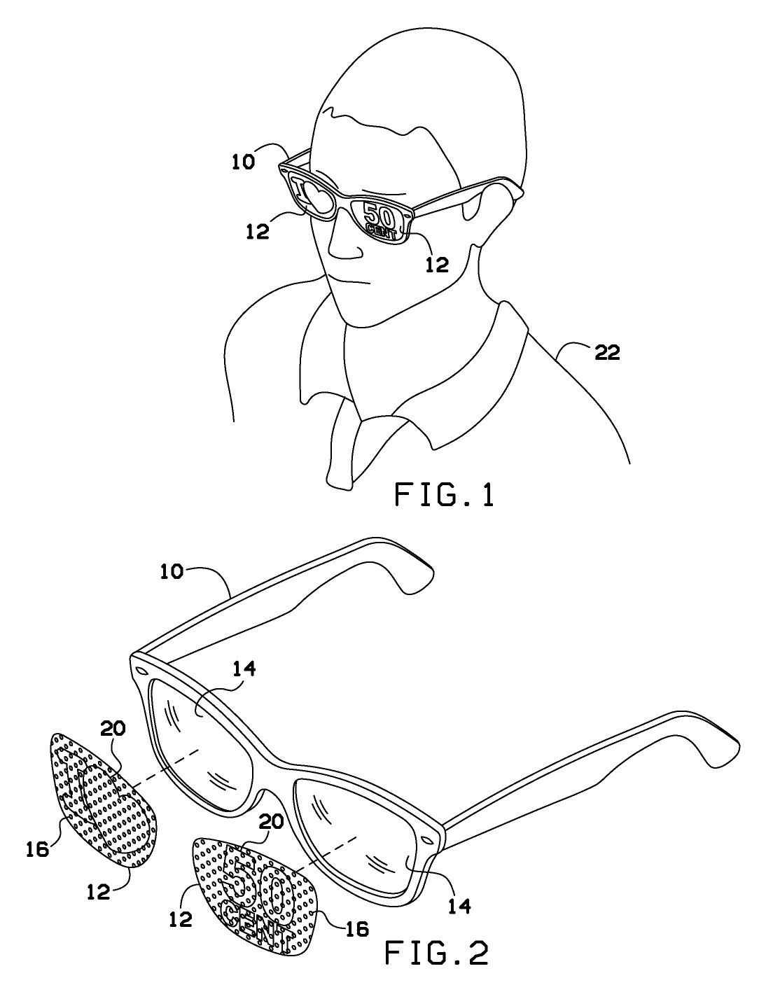

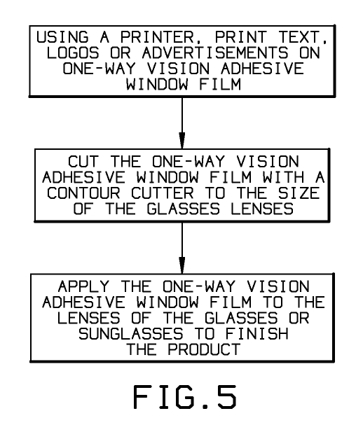

Referring to FIGS. 1 through 4, glasses 10 can be fitted with a one-way vision adhesive window film 12. The one-way vision adhesive window film 12 can be cut to size to fit over the lenses 14 of the glasses 10. A user 22 can wear the glasses 10 to support an advertising/marketing campaign, for promotional purposes, for a company's contest, at a party sponsored by a company having their logo on the glasses, or the like.

The one-way vision adhesive window film 12 can include a plurality of perforations 16. In some embodiments, the one-way vision adhesive window film 12 can be perforated up to about 50% visibility. In some embodiments, the perforations 16 can be holes up to about 1.8 mm in diameter.

The one-way vision adhesive window film 12 can include a printed text, graphic or advertisement 20 (also referred to as printed design 20). The printed design 20 can be made with, for example, an ecosolvent or solvent or water-based ink or pigment ink printer. The printed design 20 can be designed with a computer system, such as a MAC-based or PC-based computer system, with graphics software, such as Illustrator®, Corel Draw®, Photoshop®, or the like.

The one-way vision adhesive window film 12 can be applied to the lenses 14 with an adhesive 18. The adhesive 18 can be an easy-release adhesive allowing the one-way vision adhesive window film 12 to peel from the lenses 14 when the user 22 desires the one-way vision adhesive window film 12 to be removed. In some embodiments, the adhesive 18 may be a peel and stick adhesive or could be designed as a cling-type adhesive.

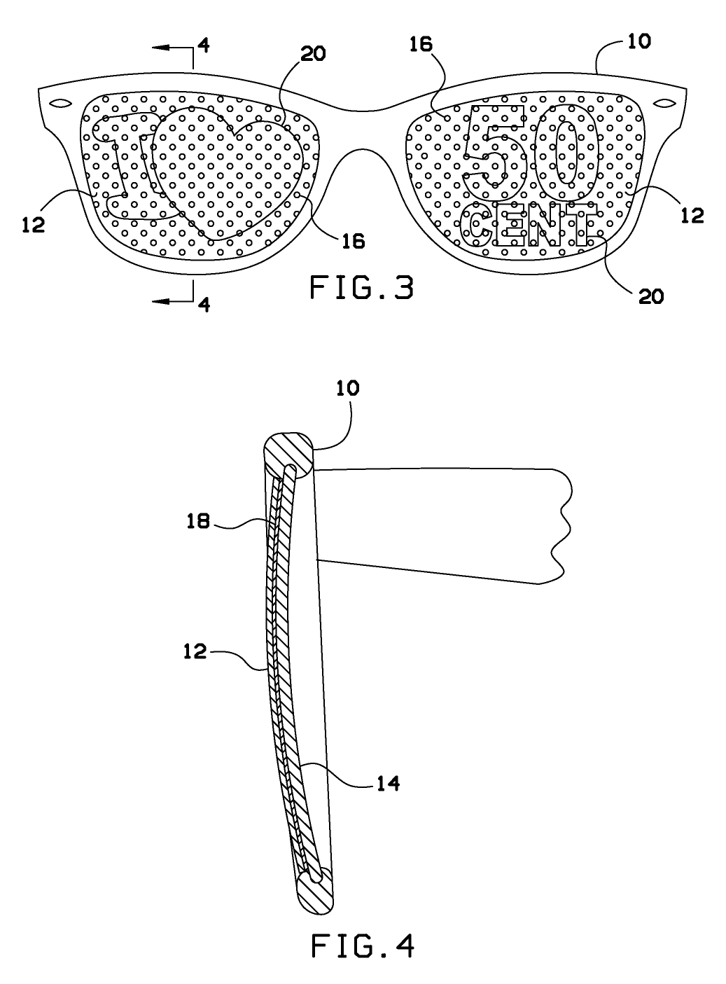

While FIG. 3 shows a particular form for the printed design 20, various printed designs are contemplated within the scope of the present invention. Such printed designs could include text, graphics, logos, trademarks, advertisements, marketing messages, or the like.

Referring to FIG. 5, a method for making advertising glasses includes using a printer to print text, logos or advertisements on one-way vision adhesive window film. The film can them be cut with a contour cutter to the size of the lenses of the glasses. The film can then be applied to the lenses of the glasses to finish the product.

The advertising glasses can be worn at events, parties, gatherings, or just by individuals showing support to the advertiser. In some embodiments, users can be urged to take pictures of themselves wearing the glasses and post such pictures on their social media pages. Such urging could be in the form of a contest, where a prize is given out to the user posting their picture with the advertising glasses, for example. Social media picture posting can provide many different users with the advertising message.

It should be understood, of course, that the foregoing relates to exemplary embodiments of the invention and that modifications may be made without departing from the spirit and scope of the invention as set forth in the following claims.

What is claimed is:

1. An advertising system comprising:
a pair of glasses having lenses;
a one-way vision adhesive window film operable to be adhered to the lenses of the pair of glasses; and
a printed advertising/marketing message disposed on the one-way vision adhesive window film.

2. The advertising system of claim 1, further comprising a plurality of perforations disposed in the one-way vision adhesive window film.

3. The advertising system of claim 2, wherein the plurality of perforations are holes having a diameter of about 1.8 mm.

4. The advertising system of claim 2, wherein the plurality of perforations create up to 50% visibility through the one-way vision adhesive window film.

5. The advertising system of claim 1, further comprising an adhesive to secure the one-way vision adhesive window film to the lenses of the pair of glasses.

6. An advertising system comprising:
a pair of glasses having lenses;
a one-way vision adhesive window film operable to be adhered to the lenses of the pair of glasses;
a plurality of perforations disposed in the one-way vision adhesive window film;
an adhesive to secure the one-way vision adhesive window film to the lenses of the pair of glasses; and
a printed advertising/marketing message disposed on the one-way vision adhesive window film.

7. The advertising system of claim 6, wherein the plurality of perforations are holes having a diameter of about 1.8 mm.

8. The advertising system of claim 6, wherein the plurality of perforations create up to 50% visibility through the one-way vision adhesive window film.

9. A method of advertising, comprising:
providing pair of glasses having lenses with a one-way vision window film disposed thereupon;
printing advertisement material on the one-way vision window film; and
urging a user to wear the glasses.

10. The method of claim 9, further comprising cutting a plurality of perforations in the one-way vision window film.
